(19) United States
(12) Patent Application Publication
(10) Pub. No.: US 2024/0108018 A1
(43) Pub. Date: Apr. 4, 2024

(54) MIXED LAYERED BISCUIT

(71) Applicant: Donald Jordan Davenport, Troy, MI (US)

(72) Inventor: Donald Jordan Davenport, Troy, MI (US)

(21) Appl. No.: 17/936,671

(22) Filed: Sep. 29, 2022

(51) Int. Cl. A21D 13/17; A21D 13/47; A21D 13/80

(52) U.S. Cl. CPC A21D 13/17; A21D 13/47; A21D 13/80

(57) ABSTRACT

The property of this invention is to create an original artistic design in a unique baked product comprised using a specific combination blend of fruit, chocolate, mint and marshmallow, to create a vertical mixed layered biscuit. The base of the food product is oatmeal, dough and raisins, with a layer of fruit on the top of the base and on top of the fruit, is marshmallow and on top of the marshmallow, is chocolate, mint and or, a fruit product.

### REFERENCES CITED USPC

### U.S. Patent Documents

U.S. Pat. No. 7,431,955 B2 Oct. 7, 2008 Helen F Pratt
U.S. D809,741 S Feb. 13, 2018
US 2022/0030905 A1 Feb. 3, 2022
US 11m234m443 B2 Feb. 1, 2022 Erik Kashnikow
US 2021/0244044 A1 Aug. 12, 2021 Hansen
US 2020/0253236 A1 Aug. 13, 2020 Schechter
DES 404,887 Feb. 2, 1999 Pamela Burgess
U.S. D557,876 S Dec. 25, 2007 Robin V. Webster
Des 412,704 Sep. 14, 1999 Susan L. Lucus
D 458,003 S Jan. 4, 2002 Alan P. Douglas
D 509,341S Sep. 13, 2005 Pamela Burgess
D 510,787S Oct. 25, 2005 Pamela Burgess
D 216,660 March 1970 Corn
D 117,043 October Corn
D99697 May 1963 Corn
D 99670 May 1963 Kiwala
D 99669 May Huber
D 96225 July 1935 Brennon
D 21087 September Bayle
D 2185 September 1891 Bayle
D 16849 August Stauffer
D 16848 August Stauffer
D 806,350 Nov. 19, 2015 Berhard Ansher
U.S. D830,035 S Oct. 9, 2018 Katie Jane Stotko
D 737,017 S Aug. 25, 2015 Deanna L. Pratt
D 458,603 S Jun. 4, 2002 Alan Douglas
D 615,277 S May 11, 2010 Cathron Brooks
D 659,346 S May 15, 2012 Barbra Fox
D 289,100 Apr. 7, 1987 Frish
D 264,390 May 1982 Longetal
U.S. Pat. No. 10,499,681 B2 Dec. 10, 2019 Katherine D. Leblanc
D 945,736 S Mar. 15, 2022 Katie jane Stofko
U.S. Pat. No. 8,739,462 B2 Jun. 3, 2014 Rob Swiatek
U.S. Pat. No. 10,624,357, B2 Apr. 21, 2020 Monica E. Millner
U.S. Pat. No. 10,206,412 B2 Feb. 19, 2019 Tamra L. Dicus
U.S. Pat. No. 7,651,709 B2 Jan. 26, 2010 Anthony Weier
U.S. D524,513 S Jul. 11, 2006 Robin Webster
U.S. Pat. No. 5,702,740 Dec. 30, 1997 Leo B. Tentoni
U.S. Pat. No. 5,229,149 Jul. 20, 1993 Steven Weinstein
U.S. Des. 289,940 May 26, 1987 Bernard Ansher
Des 299,080 Dec. 27, 1988 Bernard Ansher
D. 65,933 11/1924 Schall D1.127
D. 99,669 5/1936 Brennan D1/115 X
D. 130,164 10/1942 Wise D1/122 X
US 20180035677A1 Sep. 22, 2016

### Foreign Patent Documents

1005700 11/1982 United Kingdom
1014874 3/1984 United Kingdom
1018309 3/1984 United Kingdom
1018308 3/1984 United Kingdom
1 Claim 4 drawing sheets.

### DESCRIPTION

This is a baked biscuit product consisting of food layers vertically aligned that the top is directly above the bottom: each separate to create a unique and artistic design, each having separate flavors are comprised in a specific vertical arrangement combined with melted Marshmallow, creates the artistic flowing design.

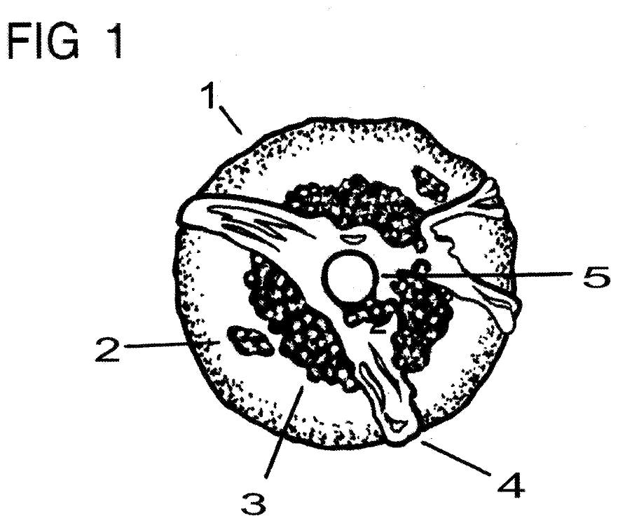

FIG. 1 is a top view of a baked good created by using a combination of food products vertically integrated together to create an embellished biscuit.
1. Oatmeal dough
2. Raisins
3. Fruit mix
4. Marshmallow
5. Fruit

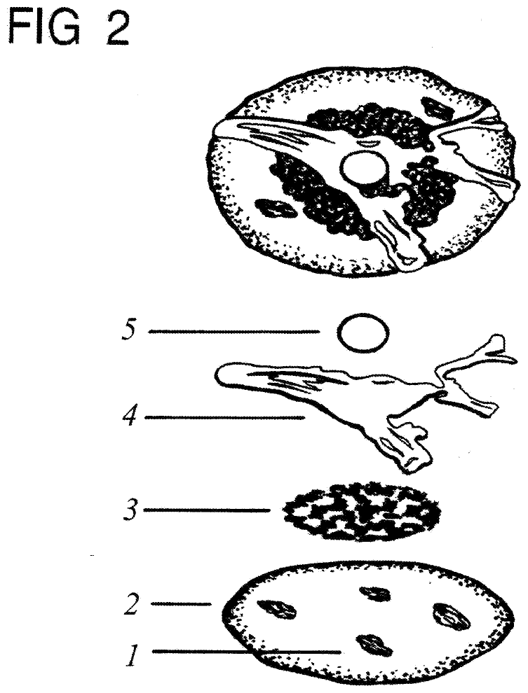

FIG. 2 is a perspective view illustrates a combination of food products integrated in vertical layers to create an embellished baked product.
1. Oatmeal dough
2. Raisins
3. Fruit mix
4. Marshmallow
5. Fruit

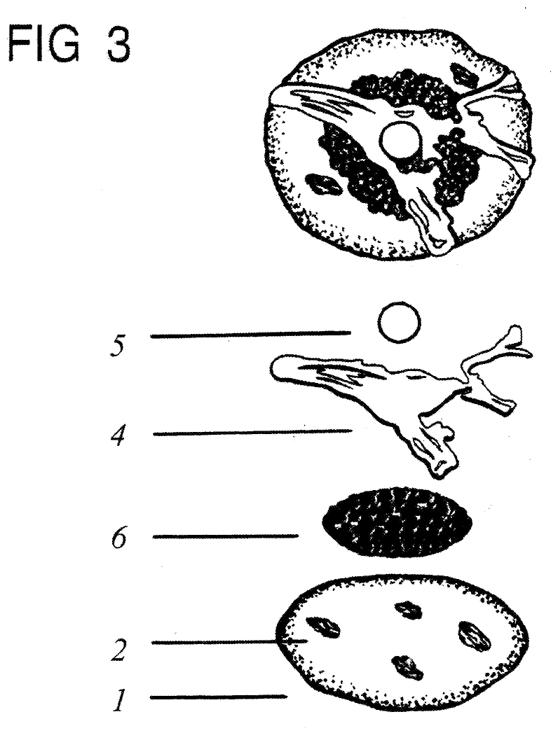

FIG. 3 is a perspective view illustrates a combination of food products integrated in vertical layers to create an embellished baked product.
1. Oatmeal dough
2. Raisins
6. Chocolate
4. Marshmallow
5. Fruit

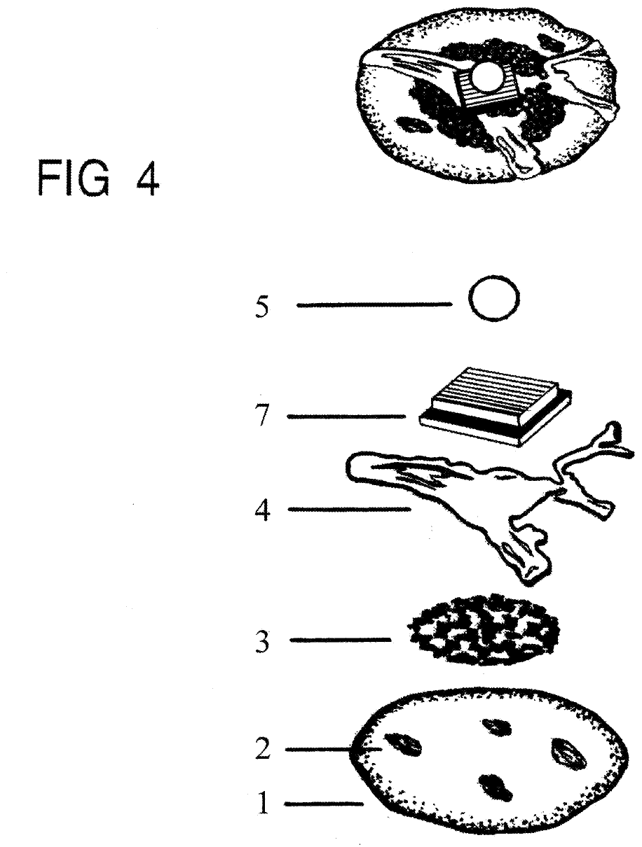

FIG. 4 is a perspective view illustrates a combination of food products integrated in vertical layers to create an ornate embellished artistic baked product.
1. Oatmeal dough
2. Raisins
3. Fruit
4. Marshmallow
7. Chocolate Mint
5. Fruit

### BACKGROUND OF THE INVENTION

There are many varieties in biscuits and cookies, blending ingredients to create a brand product to include embellishment, flavor, texture and embossing. This mixed layered ornate biscuit is a unique baked good product in appearance, flavor and design, by combining melted marshmallow using a specific arrangement, together with pastry food products creates an original artistic value in a baked product.

1. This is an embellished artistic mixed layered food product a biscuit created by using a specific process and arrangement, using a combination of food products and melted marshmallow, creates a mixed layered biscuit, as shown and described.
